(19) United States
(12) Patent Application Publication
(10) Pub. No.: US 2026/0044414 A1
(43) Pub. Date: Feb. 12, 2026

(54) RE-PROCESSING FOR SUBSURFACE DATA PLATFORM INGESTION WORKFLOW SERVICES

(71) Applicant: Schlumberger Technology Corporation, Sugar Land, TX (US)

(72) Inventors: Devesh Bajpai, Pune (IN); Mahesh Kumar Daksha, Pune (IN); Shishu Suman, Pune (IN); Khileshwar Prasad Sahu, Pune (IN); Ashish Deole, Pune (IN)

(21) Appl. No.: 19/289,426

(22) Filed: Aug. 4, 2025

(30) Foreign Application Priority Data
Aug. 7, 2024 (IN) 202411059742

(51) Int. Cl. G06F 11/14

(52) U.S. Cl. CPC G06F 11/1415; G06F 2201/805

(57) ABSTRACT

Re-processing for subsurface data platform ingestion workflow services include processing multiple failure messages of a failure message file corresponding to a correlation identifier (id) identifying a data ingestion job, to obtain multiple groups corresponding respectively to multiple failure stage identifiers (ids). The re-processing further includes initiating a re-processing request for a first group of the multiple groups corresponding to a first failure stage id of the multiple failure stage ids, the re-processing request including the first group, the first failure stage id and the correlation id. The re-processing further includes re-processing the first group through a processing stage of the data ingestion job, the processing stage identified by the first failure stage id, to obtain a status of the re-processing request.

### CROSS REFERENCE TO RELATED APPLICATION

This application claims priority to and the benefit of Indian Application No. 202411059742, entitled “RE-PROCESSING FOR SUBSURFACE DATA PLATFORM INGESTION WORKFLOW SERVICES,” filed Aug. 7, 2024, which is hereby incorporated by reference in its entirety for all purposes.

### BACKGROUND

Subsurface data platforms are standards-based data platforms used in the oil and gas industry that integrate exploration, development, and wells data. The development of the standards of subsurface data platforms is an outcome of collaborative efforts between oil and gas operators, cloud services companies, and other technology providers. Subsurface data platforms are based on a cloud-native reference architecture with a goal to reduce data silos and facilitate dataflow across the entire energy exploration and production life cycle. Full scale implementation of a standards-based reference architecture of subsurface data platforms varies between organizations. Subsurface data platforms provide standardized data models, application programming interfaces, workflows of data ingestion, and initial processing from diverse data sources that may be found in the energy industry ecosystem. Data generated by sensors and other monitoring devices may be logged and/or streamed from diverse field and processing locations. The data is then ingested in bulk, or in batches, to the subsurface data platform. The scale of data ingestion is in the magnitude of millions of data records being processed in each ingestion job. The ingested data is further processed in several processing stages into pre-defined schemas, that may in turn, form pre-defined instances, or pre-defined entities. The ingestion of data through multiple processing stages may give rise to the occurrence of failures in ingesting all, or a part of, the data records. Due to the scale and computationally expensive task of data ingestion, challenges arise in identifying the failed records, identifying the processing stage at which failure occurred, and which failed records may be re-processable.

### SUMMARY

Re-processing for subsurface data platform ingestion workflow services include processing multiple failure messages of a failure message file corresponding to a correlation identifier (id) identifying a data ingestion job, to obtain multiple groups corresponding respectively to multiple failure stage identifiers (ids). Each group of the multiple groups includes multiple record ids respectively identifying corresponding multiple records. The re-processing further includes initiating a re-processing request for a first group of the multiple groups corresponding to a first failure stage id of the multiple failure stage ids, the re-processing request including the first group, the first failure stage id and the correlation id. The re-processing further includes re-processing the first group through a processing stage of the data ingestion job, the processing stage identified by the first failure stage id, to obtain a status of the re-processing request.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows a block diagram of a workflow for data ingestion from a subsurface data platform, in accordance with one or more embodiments.

FIG. 3 shows a flowchart for re-processing failed records of a data ingestion workflow, in accordance with one or more embodiments.

FIG. 4 shows a flowchart for decoding a failure message, in accordance with one or more embodiments.

FIG. 5 shows an example of a failure message and re-process request parameters, in accordance with one or more embodiments.

FIG. 6A and FIG. 6B show a computing system, in accordance with one or more embodiments.

Like elements in the various figures are denoted by like reference numerals for consistency.

### DETAILED DESCRIPTION

One or more embodiments are directed to failure reporting and re-processing of specific data records from data ingestion jobs executing as part of subsurface data ingestion services on subsurface data platforms. Failure messages corresponding to a data ingestion job identifier (id), are monitored, and filtered based on one or more of an error message, error code and failure stage. Records corresponding to recoverable error codes and/or messages are grouped by failure stage. The groups of records are re-processed, and the success or failure status of the re-processing of the groups of records may be reported to the operator or user.

Data ingestion jobs refer to the process of bringing large volumes of raw data into the subsurface data platform. The raw data may originate from seismic monitoring, well logging, wellbore and well planning. The raw data is further mapped to pre-defined schemas (PDS) that serve as the basis for the data models within the subsurface data platform. A data ingestion job further entails the creation and addition of metadata corresponding to the mapped raw data to the subsurface data platform to render the mapped raw data searchable and query-able. One or more PDS instances may be merged or otherwise combined to create pre-defined entities (PDE) which are curated instances of the combined PDS instances. The process of creating PDEs is referred to as mastering, or enrichment. Thus, data ingestion is a computationally expensive multiple stage job, at large scale (e.g., when millions of raw data records exist). Furthermore, data ingestion jobs follow a specific workflow, i.e., a sequence of processing operations, encompassing the multiple stages of a raw file import, mapping to basic PDS, metadata creation and generation, mastering, data validation, and the like. Metadata relates to the properties of the particular kind of the data being ingested and configuration details on facilitating the data ingestion of the particular kind of data. Thus, failure may occur at one or more stages of data ingestion.

In a data ingestion job, one or more stages may report failures corresponding to at least part of the data records being processed in that stage. For example, the data import of a raw data file may fail in totality or in part. In another example, the data import into the data platform may execute successfully while specific raw data from subsurface logging may fail to be mapped successfully to a PDS. The raw data may be corrupted or the PDS mapping may not be obtainable by the mapping component(s) of the subsurface data platform.

In one or more embodiments, monitoring of data ingestion operations, identifying data records that failed to be processed, and handling batch processing may be automated by a recovery utility application. In an example, the recovery utility application may execute as a background process, monitoring the status of the data ingestion job. The recovery utility may detect a rise in the number of failure messages, increasing beyond a threshold, and further, may trigger failure message collection and decoding operations in conjunction with the status monitoring service of the subsurface data platform, to obtain multiple groups of failed records eligible for re-processing, corresponding respectively to multiple failure stage identifiers (ids). Furthermore, the recovery utility may trigger re-processing operations corresponding to one or more failure stages, including in the request, the groups of failed records corresponding to a specific failure stage id. Thus, by identifying specific records that are eligible and further re-processing the eligible records, that is, those records having a high likelihood of being successfully re-processed, overloading the computational resources of the subsurface data platform with unnecessary load may be avoided.

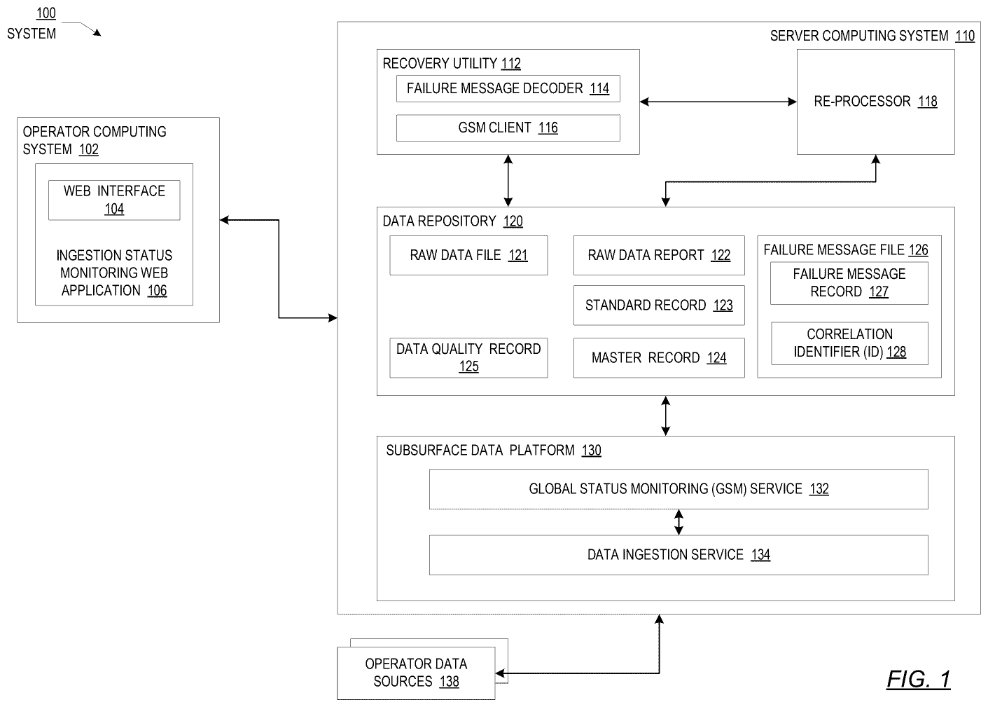

Attention is now turned to the figures. FIG. 1 shows a computing system (100), in accordance with one or more embodiments. The system (100) shown in FIG. 1 includes an operator computing system (102), a server computing system (110), and multiple operator data sources (138). Each of these components are described herein.

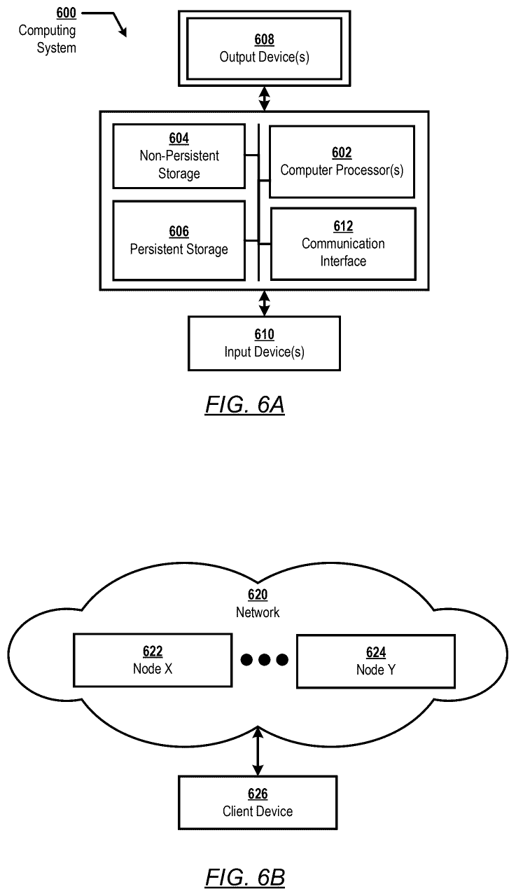

The operator computing system (102) is a computing system with one or more computer processors, data repositories, communication devices and supporting hardware and software. Examples of computer systems that may form the operator computing system (102) are described with respect to FIG. 6A. The operator computing system is communicably coupled with the server computing system (110). The operator computing system (102) may be deployed in an enterprise, field location, or plant processing location for use by an employee or other worker. The operator computing system (102) includes an ingestion status monitoring web application (106). The ingestion status monitoring web application (106) includes a web interface (104). The ingestion status monitoring web application (106) includes functionality to transmit data ingestion job requests from an operator to the server computing system (110). Further, the ingestion status monitoring web application (106) includes functionality to present updated status monitoring information related to the data ingestion jobs to the operator via the web interface (104).

As a general overview, a web-based, or web, application refers to computer programs and applications that users may access via a web browser, connecting to a remote server using Hypertext Transfer Protocol (HTTP) and Representational State Transfer (REST) protocols. The web application may execute on the server computing system (110) or another computing system and have pages or the web interface (104) served to the operator computing system (102). The web interface (104) of the ingestion status monitoring web application (106) includes graphical artifacts, for example, forms, dialog boxes, tables etc., presented to a user, or operator. The user, or operator may click, type into, or navigate online via the graphical artifacts, entering information or performing other actions.

The server computing system (110) of the system (100) shown in FIG. 1 is a computing system with one or more computer processors, data repositories, communication devices, and supporting hardware and software. The server computing system (110) is configured to execute one or more applications, such as a recovery utility (112) and a re-processor (118). An example of one or more computer processors that may be part of the server computing system (110) is the computer processor(s) (602) described in reference to FIG. 6A. The one or more computer processors are hardware or virtual processors which may execute computer readable program code that defines one or more applications, including the recovery utility (112), and the re-processor (118). The server computing system (110) may be in a distributed computing environment. An example of a computer system and network that may form the server computing system (110) is described with respect to FIG. 6A and FIG. 6B.

As shown in FIG. 1, the server computing system (110) includes a data repository (120). The data repository (120) is a type of storage unit or device (e.g., a file system, database, data structure, or any other storage mechanism) for storing data. The data repository (120) may include multiple different, potentially heterogeneous, storage units and/or devices. An example of a physical storage device that may be part of the server computing system (110) is the persistent storage device(s) (606) described in reference to FIG. 6A.

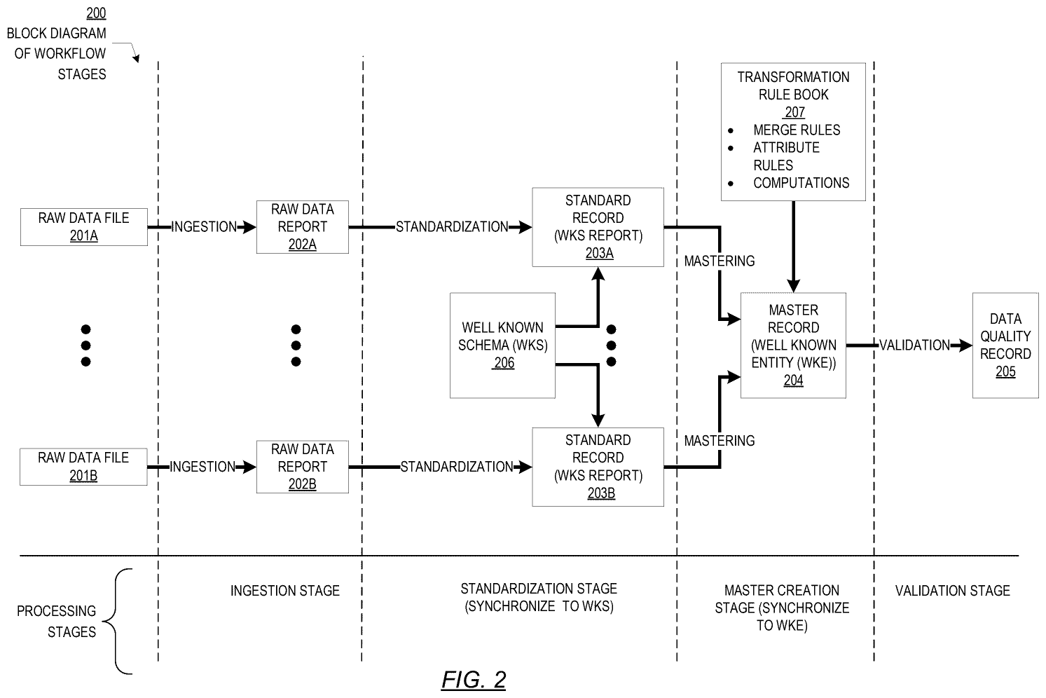

The data repository (120) includes one or more of raw data file(s) (121), raw data report(s) (122), standard record(s) (123), master record(s) (124) and data quality record(s) (125). The raw data file(s) (121) may be one or more files obtained from the subsurface data platform (130). The raw data file (121) includes multiple raw data records that are ingested from one or more of the operator data sources (138) into the subsurface data platform (130). The raw data file (121) may be in a (SEG-Y) format, representing seismic data. The SEG-Y (also referred to as “SEG Y”) file format is a widely used data standard for exchanging geophysical data, developed by the Society of Exploration Geophysicists (SEG). The SEG-Y format is commonly used for seismic data storage, or Ground Penetrating Radar (GPR) raw data. Other raw data file formats include log ASCII standard (las) format, representing well logging data, Wellsite Information Transfer Standard Markup Language (witsml) format, representing wellbore data, and other diverse formats used to represent well planning information. Each of the one or more raw data report(s) (122), standard record(s) (123), master record(s) (124), and data quality record(s) (125) may include the raw data records from the raw data file (121) mapped to one or more pre-defined schemas (PDS). More specifically, The raw data reports(s) (122) may be obtained by processing the raw data file(S) (121). Subsequently, standard record(s) (123) may be obtained by processing the raw data report(s) 122. Further, master record(s) (124) may be obtained by processing the standard record(s) (123). Furthermore, data quality record(s) (125) may be obtained by processing the master records (124). Further, each of the one or more raw data report(s) (122), standard record(s) (123), master record(s) (124) and data quality record(s) (125) may be in JavaScript Object Notation (JSON) format. Other formats may be used, for example, YAML Ain′t Markup Language (YAML), extensible Markup Language (XML), Hypertext Markup Language (HTML), etc. A more detailed overview of the generation of the diverse data records of the data repository via a workflow of a data ingestion job is provided in reference to FIG. 2.

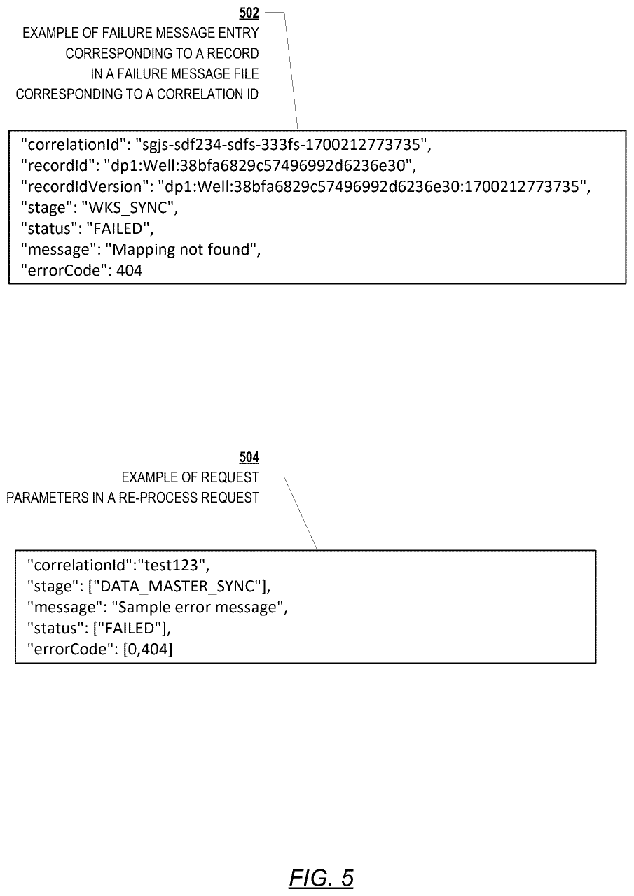

The data repository (120) further includes a failure message file (126). The failure message file (126) includes one or more failure message record(s) (127) corresponding to a correlation identifier (id) (128). The correlation id (128) corresponds to a data ingestion job. The correlation id (128) is the identifier of a data ingestion job and is used to track the multiple stages of the data ingestion job across the various components performing operations of the data ingestion (e.g., mapping to a PDS, metadata generation, mastering one or more PDS records to generate a pre-defined entity (PDE), etc.). A more detailed description of the failure message record (127) is provided in reference to FIG. 5.

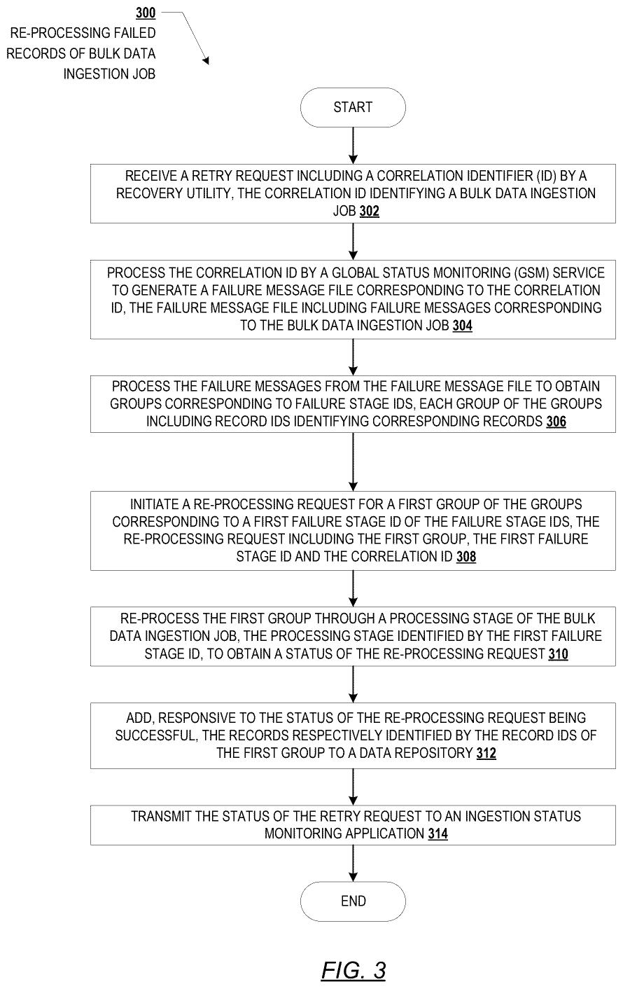

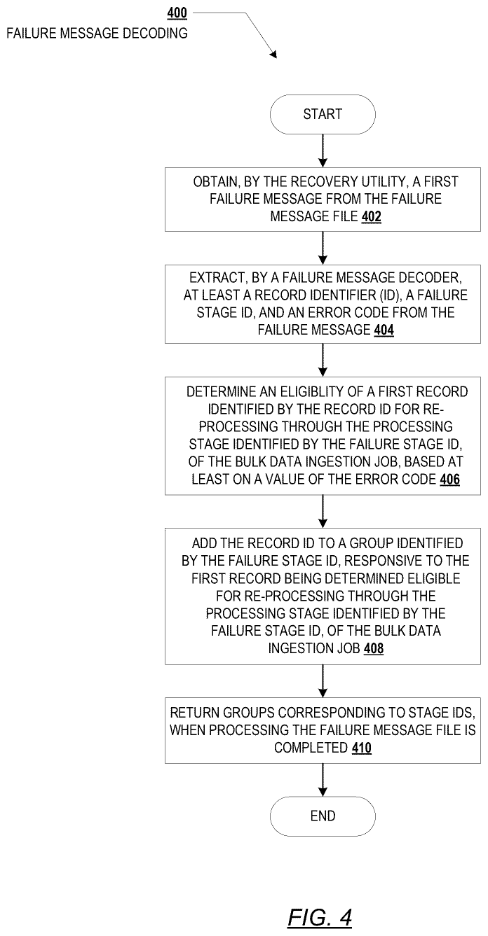

The server computing system (110) further includes a recovery utility (112). The recovery utility (112) is communicatively and operatively coupled to the re-processor (118) and the data repository (120). The recovery utility (112) is software or application specific hardware which, when executed by an at least one computer processor of the server computer system (110), essentially performs the method of FIG. 3. The recovery utility (112) includes a failure message decoder (114) and a global status monitor service (GSM) client (116). The failure message decoder (114) is software which includes functionality to essentially perform the method of FIG. 4. That is, the failure message decoder (114) decodes the failure message records (127) from the failure message file (126). The GSM client (116) is a programmatic client stub to the GSM service (132) of the subsurface data platform (130).

In the context of distributed computing, a client stub serves as a temporary replacement for a remote service or object. A client stub is an interface for a client application to interact with a remote service as if the remote service were local. The client stub acts as a proxy for the remote service. That is, the client application uses the client stub to make method calls on the remote object as if it were part of the local system. The client application receives the result parameters and/or status of the method call similar to a local function call.

The server computing system (110) further includes a re-processor (118). The re-processor (118) is operatively and communicatively coupled to the recovery utility (112) and the data repository (120). The re-processor (118) includes functionality to initiate, or trigger, re-process requests to the subsurface data platform (130). The recovery utility (112) may operate in conjunction with the re-processor (118) to re-process failed records that are eligible for re-processing.

In continuing reference to FIG. 1, the server computing system (110) includes a subsurface data platform (130). As shown in FIG. 1, the subsurface data platform (130) is shown as a component of the server computing system (110). Different architectural arrangements of the server computing system (110), the subsurface data platform (130), the data repository (120) and the respective included components thereof, are possible. For example, the subsurface data platform (130) may be included as a layer of the server computing system (110). In one arrangement, the subsurface data platform (130) may share the data repository (120) and Global Status Monitoring (GSM) service (132) with the server computing system (110). In another example, the data repository (110) may be included in the subsurface data platform (130) executing on a separate computing system, and communicatively coupled to the server computing system (110). In yet another example, the subsurface data platform (130) may execute on a separate computing system and may be communicatively coupled to the server computing system (110), and the server computing system (110) may include the data repository (120).

In an example, the subsurface data platform may be an implementation of the open subsurface data universe (OSDU®) reference architecture. As a general overview, the OSDU® reference architecture is a cloud-native subsurface reference architecture. The OSDU® reference architecture is designed to facilitate seamless data flow across the entire energy exploration and production lifecycle, (e.g., reservoir modeling, seismic monitoring, well bore data, etc.). The term “cloud-native” refers to the approach of building, deploying, and managing a modern application in cloud computing environments. The term “reference architecture” refers to a blueprint for building systems and/or applications that meet specific requirements. Reference architectures of software platforms provide guidance on best practices and patterns for software development, with focus on common structures and integrations. In other words, reference architectures are template solutions to create consistent architectures, data types, and data integration workflows within a particular domain.

Accordingly, as shown in FIG. 1, the subsurface data platform (130) is an implementation of the OSDU® reference architecture. Other implementations of the subsurface data platform (130) are possible, for example, Petrel®, Kingdom™, Geographix™. The aforementioned are industry-specific subsurface data platforms, and are proprietary (i.e., not open source). As shown in FIG. 1, the subsurface data platform (130) includes at least a data ingestion service (134) and a global status monitoring (GSM) service (132). The subsurface data platform (130) may include other components for additional functionality.

The data ingestion service (134) of the subsurface data platform (130) is configured to ingest raw data from one or more operator data source(s) (138). The raw data may include sensor data, seismic data, well-logging data, wellbore data, etc. The raw data may undergo cleaning, formatting, and structuring before being stored in a raw data file. Further, the data ingestion service (134) may perform operations on the raw data file, including mapping to PDS, creation of metadata, mastering one or more PDS to generate a PDE, and storing various record types in the data repository (120).

The subsurface data platform (130) includes a global status monitoring (GSM) service (132). The GSM service (132) is query-able via application programming interface (API) calls. The GSM service (132) API calls may be made by a client application including a GSM client stub, for example the GSM client (116), as shown in FIG. 1. The GSM service (132) is configured to maintain status records of data ingestion jobs.

In one or more embodiments, the GSM service (132) is an implementation of the global status monitoring service component of the OSDU® reference architecture. The GSM service in the OSDU® reference architecture is a framework that provides a mechanism to track the status of data journeys on the subsurface data platform (130).

As a general overview, millions of records spread across multiple datasets may be ingested by the data ingestion service (134). The requester of the data ingestion job may use visibility into the status of the data as the data moves through the workflow, regarding completion of each processing stage, the status of each processing stage (e.g., “success,” “failure,” “partial success,” “skipped,” etc.), reasons for and details of the failure, and other notifications. To this end, the data ingestion service (134) may publish status messages corresponding to each processing stage of the workflow to a message queue in the GSM service (132). The status message may be associated with the data ingestion job correlation id. Thus, a requester may subscribe to the message queue to obtain information on events of status change for a specific correlation id via API calls. The GSM service (132) tracks the progress of data ingestion and processing and provides real-time updates.

While FIG. 1 shows a configuration of components, other configurations may be used without departing from the scope of one or more embodiments. For example, various components may be combined to create a single component. As another example, the functionality performed by a single component may be performed by two or more components.

Turning to FIG. 2, a block diagram of the stages of the workflow of a data ingestion job is presented. Blocks 201A and 201B represent one or more raw data files, originating from operator data sources, for example, the operator data sources shown in FIG. 1. Blocks 201A and 201B correspond to the raw data file(s) of FIG. 1. The raw data files may be in formats such as comma separated value (CSV) files, system logs, sensor data, text files, etc. Additionally or alternatively, raw data may be streamed from the operator data sources into the subsurface data platform which may create file dumps of the streamed raw data. Blocks 201A and 201B undergo a first processing stage, namely the ingestion stage. In the ingestion stage, the raw data files are converted to JSON records, shown as the raw data reports of Blocks 202A and 202B. Blocks 202A and 202B correspond to the raw data report of FIG. 1.

Blocks 202A and 202B, representing raw data reports, undergo a second processing stage, namely, a standardization stage of the workflow. In the standardization stage, the data ingestion service maps the JSON records of the raw data reports (Blocks 202A and 202B) to a pre-defined schema (PDS), shown as Block 206 in FIG. 2. A PDS is a JSON schema that defines the format, attributes, and attribute relationships of data. Thus, standardization entails using the PDS to map the data of the raw data report to the PDS. Standardization may encompass aggregation, transformation, and computation operations to fit the records raw data report to the required attributes, attribute relationships, and format of the PDS of Block 206. The output of the transformation stage is one or more standard records, shown as Blocks 203A and 203B. Blocks 203A and 203B correspond to the standard record(s) of FIG. 1. The standard record(s) are also referred to as “PDS reports.” The terms “standard records” and “PDS reports” are interchangeable as used in the current specification and refer to the standard record of FIG. 1 and/or Blocks 203A and 203B of FIG. 2.

The next processing stage in the workflow of the data ingestion job is the master creation stage. Master record(s), represented by Block 204, are generated from one or more standard records, through a process called mastering. The mastering process may also be referred to as enrichment. In the master creation stage, one or more standard records undergo a set of transformations to form a consumable schema for discovery. In other words, the formation of a master record is curated from one or more standard records. The set of transformations may include merge rules, renaming attributes, adding missing attributes, etc. The transformation “rule book” is shown in FIG. 2 as Block 207. The resulting master record is also referred to as a pre-defined entity (PDE). The master record represented by Block 204 corresponds to the master record of FIG. 1.

As shown in FIG. 2, the final processing stage is the validation stage. The validation stage entails the validation of the master record resulting in the generation of a data quality record corresponding to the master record. Block 205 represents a data quality record and corresponds to the data quality record of FIG. 1. In the validation stage, the data of the master record is validated and verified to ensure that the data is trustworthy, consistent and is compliant with the business rules governing the organization that is the owner of the data. In one or more embodiments, the validation stage may involve human oversight and data management.

The multi-stage workflow shown in FIG. 2 illustrates the various stages, processes, and transformations that raw data undergoes to render the data into searchable, trackable, and pre-defined entities. Thus, it is desirable to identify, by interpreting and decoding failure messages generated by any of the stages, processes and transformations shown in FIG. 2, the exact stage at which the failure occurred, to make a re-processing attempt for a specific record at that stage if the record proves eligible for re-processing.

Accordingly, FIG. 3 shows a flowchart of a method for re-processing failed records of a data ingestion job, in accordance with one or more embodiments. The method of FIG. 3 may be implemented using the system of FIG. 1 and one or more of the steps may be performed on or received at one or more computer processors.

While the various steps in the flowchart 300 are presented and described sequentially, at least some of the steps may be executed in different orders, may be combined, or omitted, or performed independently, and at least some of the steps may be executed in parallel. Furthermore, the steps may be performed actively or passively.

The flowchart 300 starts at Block 302. In Block 302, a retry request including a correlation identifier (id) is received by a recovery utility. In an example, the retry request originates from an operator using an operator computing system as shown in FIG. 1. In one or more embodiments, the operator may monitor status updates presented via a web interface, updated by an ingestion status monitoring web application, executing on the operator computing system, after initiating a data ingestion job. The data ingestion job is identified by the correlation id.

In Block 304, the correlation id is processed to generate a failure message file, including failure messages corresponding to the correlation id. In an example, the recovery utility requests the GSM service executing on the subsurface data platform, to generate a failure message file corresponding to the correlation id, which is presented as a parameter of the request to the GSM service. In one or more embodiments, the recovery utility may make the request via the API exposed by the GSM client included in the recovery utility.

In Block 306, the failure messages from the failure message file are processed to obtain groups corresponding to multiple failure stage ids. A failure stage id identifies a processing stage of the data ingestion job, as shown in FIG. 2. Each group includes multiple record ids respectively identifying multiple records. More particularly, a record id included in a particular group identifies a record that was not successfully processed in the processing stage (e.g., the processing stages shown in FIG. 2) associated with that particular group. In one or more embodiments, Block 306 is implemented by the method shown in FIG. 4. Thus, the record ids of a group identify records previously unsuccessfully processed in the processing stage of the data ingestion job associated with, or corresponding to, the group.

In Block 308, re-processing is initiated for the groups corresponding to the failure stage ids obtained by processing the failure message files. In an example, a re-processing request for a first group of the groups corresponding to a first failure stage id of the failure stage ids is initiated. The re-processing request includes the first group, the first failure stage id, and the correlation id of the data ingestion job. In one or more embodiments, the requests may be initiated in sequential order in accordance with the order of the processing stages of the data ingestion job. In other embodiments, the requests may be initiated in parallel. In one or more embodiments, the recovery utility may request the re-processor to perform the re-processing operation.

In Block 310, the first group of Block 308 is re-processed through the processing stage of the data ingestion job identified by the failure stage id. In an example, the re-processing operation is performed by the re-processor shown in FIG. 1, and a status of the re-process request is obtained by the recovery utility. In one or more embodiments, the re-processor may additionally enqueue the status of the re-processing operation in the message queue of the GSM service.

In Block 312, responsive to the status of the re-processing request being successful, the multiple records respectively identified by the multiple record ids of the first group are added to the data repository. That is, the successfully re-processed records are added to the data repository Alternatively, the re-processing operation may result in a failure to re-process the records identified by the record ids of the first group. In this case, the re-processor may return a “failure” status message to the GSM service. Notably, the terms “success” and/or “failure” may or may not be literally used in the status message. The terms as used herein should be interpreted as capturing the semantic intent of the status message. In one or more embodiments, the recovery utility may obtain the status of the re-process request initiated by the recovery utility from the GSM service.

In Block 314, the status of the retry request is transmitted to the ingestion status monitoring web application. In an example, the recovery utility transmits the status of the retry request to the ingestion status monitoring web application executing on the operator computing system. In one or more embodiments, the re-processing operation of the group of record ids identifying the records for re-processing may result in a “partial success” or “skipped” message. That is, some of the records identified in the group may be re-processed successfully and the remaining records identified in the group may fail to be re-processed, or some records may not be re-processed. In this case, the status message posted by the re-processor to the GSM service may indicate the record ids identifying the records that were successfully re-processed and the record ids identifying the records that failed to be re-processed, or which were skipped (no re-processing was attempted). For example, the failure stage id may indicate that the stage for which the re-processing was attempted is the standardization stage (shown in FIG. 2). The group of record ids may include 500 records, of which 300 records are successfully re-processed, and 200 records fail to be re-processed. Accordingly, the recovery utility may report the status at a record id granularity for a specific group. That is, for a specific group, the recovery utility may report the record ids that were successfully re-processed and the record ids that failed to be re-processed. The flowchart 300 ends at Block 314.

Turning now to FIG. 4, a flowchart 400 of a method for failure message decoding is presented, in accordance with one or more embodiments. The method of FIG. 4 may be implemented using the system of FIG. 1 and one or more of the steps may be performed on or received at one or more computer processors. Further, the method of FIG. 4 corresponds to Block 306 of the flowchart 300 shown in FIG. 3.

While the various steps in the flowchart 400 are presented and described sequentially, at least some of the steps may be executed in different orders, may be combined, or omitted, and at least some of the steps may be executed in parallel. Furthermore, the steps may be performed actively or passively.

The flowchart 400 begins at Block 402. At Block 402, a failure message corresponding to a failed record, from the failure message file corresponding to the correlation id of the data ingestion job is obtained. In one or more embodiments, the recovery utility retrieves the failure message file from the data repository. The failure message file is generated by the GSM service. One example of a failure message file format is a CSV file. The failure message file includes multiple failure message records. An example of a failure message record is described in detail in reference to FIG. 5.

At Block 404, at least a record identifier (id), a failure stage id, and an error code value from the failure message is extracted. In one or more embodiments, the recovery utility includes a failure message decoder as shown in FIG. 1. The failure message decoder is configured to extract multiple fields from the failure message and interpret and analyze the failure message. More particularly, the failure message decoder may identify record ids that may be eligible for re-processing. By filtering the failure message file to select those record ids and the corresponding records that will likely be successfully re-processed, overloading the computational resources of the system of FIG. 1 with operations that are likely not to have a favorable outcome is avoided.

Accordingly in Block 406, the eligibility of a record identified by the record id from the failure message for re-processing through the processing stage, identified by the failure stage id, of the data ingestion job is determined, based at least on the error code value of the failure message. In one or more embodiments, the error code values are indicative of the nature and severity of the error. Thresholding on the severity level may be used to determine whether the record is available for reprocessing. For example, if the error code value indicates a missing mapping, the severity of the error may be at a low to moderate severity level. In this example, the record corresponding to the record id of the error message may be determined to be eligible to undergo re-processing. In another example, the error code value may indicate that the record id is corrupted. The severity of the error may consequently be at a high severity level. In the example, the record corresponding to the record id of the failure message may be determined to be ineligible for re-processing because of the high severity level. In one or more embodiments, the failure message decoder may interpret and analyze additional fields in the failure message to determine the eligibility of a given record identified by the record id of the failure message for re-processing.

Subsequently, in Block 408, records deemed to be eligible for re-processing are added to a group identified by the failure stage id. In one or more embodiments, the steps of Blocks 402 to 408 are iterated to process the multiple failure messages of the failure message file. The result of processing the multiple messages of the failure message file processing is a set of groups. Each group of the set of groups is identified by a failure stage id. Further, each group of the set of groups includes multiple record ids, identifying records deemed eligible for re-processing in the processing stage, identified by the failure stage id. For example, at the end of multiple iterations of Blocks 402 to 408 of the flowchart 400, a set of three groups may be created. The groups may be identified by failure stage ids “INGESTION STAGE,” “STANDARDIZATION STAGE,” and “VALIDATION STAGE” respectively. The group identified by “INGESTION STAGE” may contain 200 record ids identifying 200 records that are deemed eligible for re-processing through the ingestion stage. In other words, the 200 records are highly likely to undergo re-processing in the ingestion stage successfully.

Accordingly, at Block 410, the groups corresponding to the failure stage ids are returned to the initiating component of the method presented in flowchart 400. In an example, the groups are returned in the step of Block 306 of the flowchart 300. The flowchart 400 ends at Block 410.

FIG. 5 shows an example of a failure message entry corresponding to a record in a failure message file corresponding to a correlation id, in accordance with one or more embodiments, indicated by reference numeral 502. Additionally, an example of request parameters in a re-process request is shown, indicated by reference numeral 504. The examples presented are for explanatory purposes only and not intended to limit the scope of one or more embodiments.

Reference numeral 502 indicates a block showing the fields and values that may be included in a failure message record of a failure message file. The field “correlationId” corresponds to the correlation id of the data ingestion job. The field “recordID” corresponds to the record id that failed to be processed. The field “recordIDVersion” corresponds to the GSM message which indicates the record id along with the storage version. The field “stage” corresponds to the failure stage id. As shown in the block referenced by reference numeral 502, the “stage” field has the failure stage id “PDS_SYNC”, indicating that the processing stage in which the record failed to process is the standardization stage as shown in FIG. 2. The fields “message” and “errorCode” indicate the nature of the failure and the corresponding error code. In one or more embodiments, these fields may be further analyzed by the failure message decoder to determine if the record identified by the record id is eligible for re-processing, in other words, the likelihood of a successful re-processing of the record identified by the record id.

Reference numeral 504 indicates a block showing parameters that may be included in a re-processing request. Notably, these parameters may be presented in the request in addition to the group of record ids identifying the records that are deemed eligible for re-processing. As shown in the block indicated by reference numeral 504, the parameters include a correlation id, a failure stage id, indicated by the field “stage”, an error message, indicated by the field “message”, and an error code.

The system and methods described herein automate the tasks of pinpointing the failed records and creating the payloads for the re-processing operation of failed records in a data ingestion job. By filtering the records that are highly likely to be successfully re-processed, overloading of the computational resources of the system may be avoided.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 6A, the computing system (600) may include one or more computer processor(s) (602), non-persistent storage device(s) (604), persistent storage device(s) (606), a communication interface (608) (e.g., Bluetooth interface, infrared interface, network interface, optical interface, etc.), and numerous other elements and functionalities that implement the features and elements of the disclosure. The computer processor(s) (602) may be an integrated circuit for processing instructions. The computer processor(s) (602) may be one or more cores, or micro-cores, of a processor. The computer processor(s) (602) includes one or more processors. The computer processor(s) (602) may include a central processing unit (CPU), a graphics processing unit (GPU), a tensor processing unit (TPU), combinations thereof, etc.

The input device(s) (610) may include a touchscreen, keyboard, mouse, microphone, touchpad, electronic pen, or any other type of input device. The input device(s) (610) may receive inputs from a user that are responsive to data and messages presented by the output device(s) (612). The inputs may include text input, audio input, video input, etc., which may be processed and transmitted by the computing system (600) in accordance with one or more embodiments. The communication interface (608) may include an integrated circuit for connecting the computing system (600) to a network (not shown) (e.g., a local area network (LAN), a wide area network (WAN) such as the Internet, mobile network, or any other type of network) or to another device, such as another computing device, and combinations thereof.

Further, the output device(s) (612) may include a display device, a printer, external storage, or any other output device. One or more of the output device(s) (612) may be the same or different from the input device(s) (610). The input device(s) (610) and output device(s) (612) may be locally or remotely connected to the computer processor(s) (602). Many distinct types of computing systems exist, and the aforementioned input device(s) (610) and output device(s) (612) may take other forms. The output device(s) (612) may display data and messages that are transmitted and received by the computing system (600). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (602), is configured to perform one or more embodiments, which may include transmitting, receiving, presenting, and displaying data and messages described in the other figures of the disclosure.

The computing system (600) in FIG. 6A may be connected to, or be a part of, a network. For example, as shown in FIG. 6B, the network (620) may include multiple nodes (e.g., node X (622) and node Y (624), as well as extant intervening nodes between node X (622) and node Y (624)). Each node may correspond to a computing system, such as the computing system shown in FIG. 6A, or a group of nodes combined may correspond to the computing system shown in FIG. 6A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (600) may be located at a remote location and connected to the other elements over a network.

The nodes (e.g., node X (622) and node Y (624)) in the network (620) may be configured to provide services for a client device (626). The services may include receiving requests and transmitting responses to the client device (626). For example, the nodes may be part of a cloud computing system. The client device (626) may be a computing system, such as the computing system shown in FIG. 6A. Further, the client device (626) may include or perform all or a portion of one or more embodiments.

The computing system of FIG. 6A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. It will be apparent to one of ordinary skill in the art that the technology may be practiced without these specific details. In other instances, pre-defined features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
processing, by a recovery utility, a plurality of failure messages of a failure message file corresponding to a correlation identifier (id) identifying a data ingestion job, to obtain a plurality of groups corresponding respectively to a plurality of failure stage identifiers (ids), wherein each group of the plurality of groups comprises a plurality of record identifiers (ids) respectively identifying a corresponding plurality of records;
initiating, by the recovery utility, a re-processing request for a first group of the plurality of groups corresponding to a first failure stage id of the plurality of failure stage ids, the re-processing request including the first group of the plurality of groups, the first failure stage id of the plurality of failure stage ids and the correlation id; and
re-processing, by a re-processor, the first group of the plurality of groups through a processing stage of the data ingestion job, the processing stage identified by the first failure stage id, to obtain a status of the re-processing request.

2. The method of claim 1, further comprising:
receiving a retry request including the correlation id by the recovery utility, wherein the correlation id identifies the data ingestion job.

3. The method of claim 2, further comprising:
transmitting the status of the retry request to an ingestion status monitoring web application executing on an operator computing system.

4. The method of claim 1, further comprising:
processing, by a global status monitoring (GSM) service, the correlation id to generate the failure message file corresponding to the correlation id, the plurality of failure messages corresponding to the data ingestion job identified by the correlation id.

5. The method of claim 1, further comprising:
adding, responsive to the status of the re-processing request being successful, a plurality of records of the first group of the plurality of groups to a data repository.

6. The method of claim 1, wherein processing the failure message file further comprises:
obtaining, by the recovery utility, a first failure message from the failure message file;
extracting, by a failure message decoder, at least a record identifier (id), the first failure stage id, and an error code from the first failure message; and
determining an eligibility of a first record identified by the record id for re-processing through the processing stage identified by the first failure stage id, of the data ingestion job, based at least on a value of the error code.

7. The method of claim 6, further comprising:
adding the record id to a group identified by the first failure stage id, responsive to the first record being determined as eligible for re-processing through the processing stage identified by the failure stage id, of the data ingestion job.

8. The method of claim 6, further comprising:
iteratively processing the plurality of failure messages of the failure message file to obtain the plurality of groups corresponding respectively to the plurality of failure stage ids.

9. A system comprising:
at least one computer processor;
a recovery utility, executing on the at least one computer processor and configured to:
process a plurality of failure messages of a failure message file corresponding to a correlation identifier (id) identifying a data ingestion job, to obtain a plurality of groups corresponding respectively to a plurality of failure stage identifiers (ids), wherein each group of the plurality of groups comprises a plurality of record identifiers (ids) respectively identifying a corresponding plurality of records,
initiate a re-processing request for a first group of the plurality of groups corresponding to a first failure stage id of the plurality of failure stage ids, the re-processing request including the first group of the plurality of groups, the first failure stage id of the plurality of failure stage ids and the correlation id; and
cause a re-processor to re-process the first group of the plurality of groups through a processing stage of the data ingestion job, the processing stage identified by the first failure stage id, to obtain a status of the re-processing request.

10. The system of claim 9, wherein the recovery utility executing on the at least one computer processor is further configured to:
receive a retry request including the correlation id by the recovery utility, wherein the correlation id identifies the data ingestion job.

11. The system of claim 10, wherein the recovery utility executing on the at least one computer processor is further configured to:
transmit the status of the retry request to an ingestion status monitoring web application executing on an operator computing system.

12. The system of claim 9, wherein the recovery utility executing on the at least one computer processor is further configured to:
cause a global status monitoring (GSM) service of a subsurface data platform to process the correlation id to generate the failure message file corresponding to the correlation id, the plurality of failure messages corresponding to the data ingestion job identified by the correlation id.

13. The system of claim 9, wherein the recovery utility executing on the at least one computer processor is further configured to:
add, responsive to the status of the re-processing request being successful, a plurality of records of the first group of the plurality of groups to a data repository.

14. The system of claim 9, wherein the recovery utility executing on the at least one computer processor is further configured to:
obtain a first failure message from the failure message file; and
cause a failure message decoder to:
extract at least a record identifier (id), the first failure stage id, and an error code from the first failure message; and
determine an eligibility of a first record identified by the record id for re-processing through the processing stage identified by the first failure stage id, of the data ingestion job, based at least on a value of the error code.

15. The system of claim 14, wherein the recovery utility executing on the at least one computer processor is further configured to cause the failure message decoder to:
add the record id to a group identified by the first failure stage id, responsive to the first record being determined as eligible for re-processing through the processing stage, identified by the first failure stage id, of the data ingestion job.

16. The system of claim 14, wherein the recovery utility executing on the at least one computer processor is further configured to cause the failure message decoder to:
iteratively process the plurality of failure messages of the failure message file to obtain the plurality of groups corresponding respectively to the plurality of failure stage ids.

17. A method comprising:
receiving, by a recovery utility of a server computing system, a retry request from an ingestion status monitoring web application executing on an operator computing system, the retry request including a correlation identifier (id), wherein the correlation id identifies a data ingestion job;
processing, by a global status monitoring (GSM) service executing on a subsurface data platform, the correlation id to generate a failure message file corresponding to the correlation id, the failure message file comprising a plurality of failure messages corresponding to the data ingestion job identified by the correlation id;
obtaining, by the recovery utility, a first failure message from the failure message file;
extracting, by a failure message decoder of the recovery utility, at least a record identifier (id), a failure stage id, and an error code from the first failure message; and
determining an eligibility of a first record identified by the record id for re-processing through a processing stage, identified by the failure stage id, of the data ingestion job, based at least on a value of the error code.

18. The method of claim 17, further comprising:
adding, by the failure message decoder, the record id to a group identified by the failure stage id, responsive to the first record being determined as eligible for re-processing through the processing stage identified by the failure stage id, of the data ingestion job; and
iteratively processing the plurality of failure messages of the failure message file to obtain a plurality of groups corresponding respectively to a plurality of failure stage ids.

19. The method of claim 18, further comprising:
initiating, by the recovery utility, a re-processing request for a first group of the plurality of groups corresponding to a first failure stage id of the plurality of failure stage ids, the re-processing request including the first group of the plurality of groups, the first failure stage id of the plurality of failure stage ids and the correlation id; and
re-processing, by a re-processor, the first group of the plurality of groups through the processing stage of the data ingestion job, the processing stage identified by the first failure stage id, to obtain a status of the re-processing request.

20. The method of claim 19, further comprising:
adding, by the recovery utility, responsive to the status of the re-processing request being successful, a plurality of records of the first group of the plurality of groups to a data repository; and
transmitting, by the recovery utility, the status of the retry request to the ingestion status monitoring web application.
